(19) United States
(12) Patent Application Publication
(10) Pub. No.: US 2012/0051810 A1
(43) Pub. Date: Mar. 1, 2012

(54) HEATING FIXATION BELT AND IMAGE FORMING APPARATUS BY USE THEREOF

(75) Inventors: Eiichi YOSHIDA, Tokyo (JP); Susumu SUDO, Tokyo (JP); Yasuo KURACHI, Tokyo (JP); Izumi MUKOYAMA, Tokyo (JP)

(73) Assignee: KONICA MINOLTA BUSINESS TECHNOLOGIES, INC., Tokyo (JP)

(21) Appl. No.: 13/214,729

(22) Filed: Aug. 22, 2011

(30) Foreign Application Priority Data
Aug. 30, 2010 (JP) 2010-191890

(51) Int. Cl. G03G 15/20

(52) U.S. Cl. 399/333

(57) ABSTRACT

A heating fixation belt is disclosed, comprising an insulating resin layer containing fibers, a heating layer containing an electrically conductive material dispersed in a resin and having a pair of feed electrodes provided on both ends and a releasing layer, which are sequentially provided in that order.

An image forming apparatus comprising the heating fixation belt is also disclosed.

This application claims priority from Japanese Patent Application Nos. 2010-191890, filed on Aug. 30, 2010, which is incorporated hereinto by reference.

### FIELD OF THE INVENTION

The present invention relates to a heating fixation belt to allow a dry toner image formed by an electrostatic latent image development system such as electrophotography or the like to be thermally fixed onto an image support and an image forming apparatus by use of the same.

### BACKGROUND OF THE INVENTION

In an image forming apparatus such as a copier or a laser beam printer, there has been conventionally employed a technique of contact-heat-fixing an unfixed toner image which has been transferred, after toner development, onto an image support such as plain paper or the like.

A heated roller system takes time to reach the fixable temperature and requires a lot of heat energy. Recently, a heat film fixing system has become main stream from the viewpoint of shortening the time from activation of a power source to copy start (the so-called warming-up time) and energy saving.

In a fixing device (fuser) of such a heat film fixing system, there is used a seamless fixing belt in which a releasing layer of a fluororesin or the like is superimposed on the outer surface of a heat-resistant film such as polyimide.

However, in the fixing device of a heat film fixing system, for example, the film is heated through, for example, a ceramic heater and a toner image is fixed on the film surface, so that heat conductivity of the film becomes an important point. However, thinning a fixing belt film to improve thermal conductivity results in a lowering of mechanical strength, rendering it difficult to rotate at a high-speed and problems arise with image formation of high image quality and there is also produced such a problem that a ceramic heater is easily broken.

To overcome such problems, recently, there was proposed a technique in which a fixing belt is provided with a heating element and feeding the heating element directly heats the fixing belt to fix a toner image. An image forming apparatus of such a system, which features a shortened warming-up time and also quires less power consumption, is superior as a heat-fixing device in terms of energy saving and production speed.

Examples of such a technique include a heating element constituted of an electrically conductive material such as a conductive ceramic, conductive carbon or a powdery metal, and an insulating material such as an insulating ceramic or a heat-resistant resin (as described in, for example, JP 2004-281123 A), a heating belt provided with a heating layer in which a carbon nano-material and filament-formed metal particles are dispersed in a polyimide resin (as described in, for example, JP 2007-272223 A), and a fixing device using a heating belt exhibiting a positive temperature characteristic, in which a heating layer is composed of a mixture of an electrically conductive oxide and a resin (as described in, for example, JP 2006-350241 A).

### SUMMARY OF THE INVENTION

Technology development relating to a fixing device using a heating fixation belt was actively carried out but the present situation is that there has not been developed a heating fixation belt achieving lowering of resistance of the belt and exhibiting extremely enhanced flexibility, so that sufficient performance cannot be maintained over a long period of time. In actual fact, there has not been developed as yet a fixing device using a heating fixation belt exhibiting a shortened warming-up time and energy-saving performance as an advantage of a heating fixation belt.

The present invention has been achieved to resolve the foregoing problems.

Namely, the object of the present invention is to provide a heating fixation belt for use in a fixing device and capable of maintaining an appropriate resistance-lowering as a heating fixation belt over a long duration and an image forming apparatus by use thereof.

Another object of the present invention is to inhibit damage of the heating layer due a pressure at the time of fixing when a foreign material enters inside of a fixation belt, or fracture of the heating layer, caused by deformation of a fixation belt by a large power applied when taking out an image support at the time of paper jam in a fixing device. When a heating layer is damaged or fractured, an electric current is not applied in this portion, which is not heated. Therefore, it is a concern that an increase of such a portion causes fixing trouble of a toner.

The foregoing objects of the present invention can be realized by the following constitution.

One aspect of the present invention is directed to a heating fixation belt comprising an insulating resin layer containing at least fibers, a heating layer containing an electrically conductive material dispersed in a resin and provided with paired feed electrodes on both ends and a releasing layer, which are sequentially provided in that order.

Another aspect of the present invention is directed to an image forming apparatus using a heating fixation belt, as described above.

In accordance with the present invention, there can be provided a heating fixation belt for use in a fixing device and capable of maintaining an appropriate resistance-lowering as a heating fixation belt over a long duration and an image forming apparatus by use thereof.

Further, there can be inhibited damage of a heating layer by a pressure at the time of fixing when a foreign material enters inside of a fixation belt, or fracture of a heating layer, caused by deformation of a fixation belt by a large power applied when taking out an image support at the time of a paper jam in a fixing device. Therefore, it is a concern that an increase of such a portion causes fixing trouble of a toner. Even when the heating layer is fractured by a foreign material or a large surge of applied power, incorporation of a fiber in the insulating resin layer halts the damage of the resin at the fiber portion to inhibit extensive damage causing fixing trouble.

### BRIEF DESCRIPTION OF THE DRAWINGS

FIG. 1 illustrates a sectional view showing constitution of the representative heating fixation belt of the present invention.

FIG. 2 shows a schematic constitution view of a fixing device integrating a heating fixation belt according to the present invention.

FIG. 3 illustrates a sectional view of an example of an image forming apparatus of the present invention.

FIGS. 4A-4D are drawings showing the orientation direction of fibers in an insulating resin layer with respect to the direction of an electric current applied between opposed electrodes for electric power supply.

### DETAILED DESCRIPTION OF THE INVENTION

There will be further described compounds used in the present invention, constitution of a heating fixation belt, and an image forming apparatus.

A conventional heating fixation belt for use in a fixing device was comprised of a polyimide resin layer in which a carbon nano-material or filament-formed metal particles are dispersed but it was proved that such a heating fixation belt produced problems such that, when a flaw was produced on the belt, normal heat generation becomes difficult, leading to extreme deterioration in characteristics. Namely, the heating fixation belt employs a resin layer such as a polyimide, as a support, and such a heat-resistant resin is high in tensile strength and its heat resistance is sufficient, unless the resin is mischosen. However, its toughness or tear resistance is low and when flaws or a rupture occurs in a part of a heating fixation belt, an area in which no electric current is applied and an area in which an electric current larger than a normal level is applied are produced on the surface of the heating fixation belt, resulting in non-uniform distribution in temperature. Obviously, it is difficult to repair such a trouble, unless the heating fixation belt is exchanged, producing problems in practice.

It is one feature of the present invention that a heating layer was constituted by using, as a conductive material, an electrically conductive material which exhibited electric resistance close to metals as a conductive material and its combination with an insulating resin layer (support) inhibited partial ruptures of a heating fixation belt during use, which makes it feasible to provide a heating fixation belt achieving enhanced durability as well as appropriate electric resistance and warming-up characteristic.

### Constitution of Heating Fixation Belt:

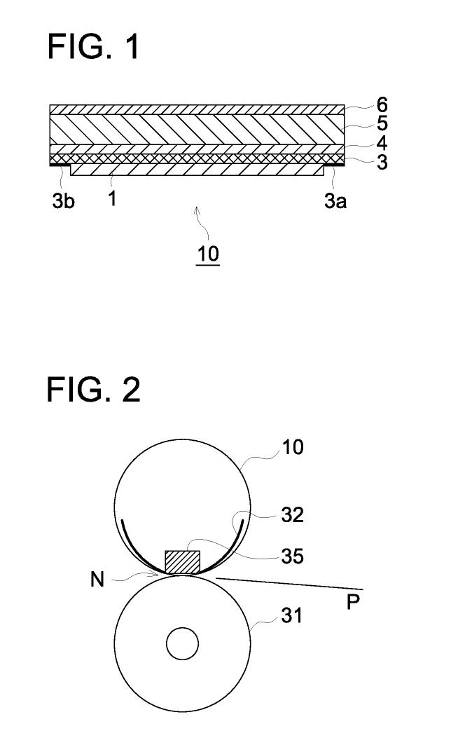

FIG. 1 illustrates a sectional view showing the constitution of a representative heating fixation belt of the present invention.

A heating fixation belt 10 comprises an insulating resin layer 1 containing at least fibers, whose main component is a heat resistant resin such as polyimide or the like. Further thereon, a heating layer 3 is formed which is provided with feeding electrodes 3a and 3b on both ends of the heating layer, and when needed, an elastomer layer 5 is disposed through a primer resin layer 4, and there is further provided a release layer as a surface layer. However, this simply shows a typical layer constitution and in the present invention, there may not be provided the primer layer 4 or the elastomer layer 5, or there may be added another functional layer.

In the heating layer 3, an electrically conductive material is contained in the heat resistant resin. The production method thereof may employ commonly known methods.

The volume resistivity of a heating layer composed of a heat resistant resin containing an electrically conductive material is determined in the manner that electrode sections are provided on both ends of the total circumference in the circumference direction of a heating fixation belt, where the resistance value on both ends is measured and a volume resistivity is calculated in accordance with the following equation:

Volume resistivity (ρ)=(R·d·W)/L (Ω·m)

where “R” is a resistance value (expressed in Q), “d” is a heating layer thickness (m), “W” is a length (m) in the circumference direction and “L” is a length (m) between electrodes.

The volume resistivity of a heating layer is preferably within the range of 8×10⁻⁶ to 1×10⁻² Ω·m.

Next, FIG. 2 shows a schematic constitution view of a fixing device integrating a heating fixation belt according to the present invention, in which a heating fixation belt 10 is pressed onto an opposed pressing roller 31 by a pressing member 35. The designation “N” shows a nip portion formed by the pressing roller 31 and the heating fixation belt 10 pressed by the pressing member 35, and the numeral 32 designates a guide member for the heating fixation belt 10.

Although not shown in FIG. 2, usually, the heating fixation belt 10 is internally supported by a roller used far support/transportation, as needed. Obviously, an image support P having an unfixed toner image passes through the nip portion, whereby the toner image is fixed onto the image support P.

### Insulating Resin Layer Containing Fibers:

In the present invention, an indispensable component constituting an insulating resin layer are fibers. Such fibers are usually contained in a heat resistant resin to form an insulating resin layer.

### Fibers Contained in Insulating Resin Layer:

Examples of fiber contained in an insulating resin layer include plant fibers such as cotton, hemp, or jute; chemical fibers such as polyester, nylon, Teflon (registered name), aramid, or poly(phenylene sulfide); glass fibers and carbon fibers. Of these, Teflon (registered name) and aramid are preferred.

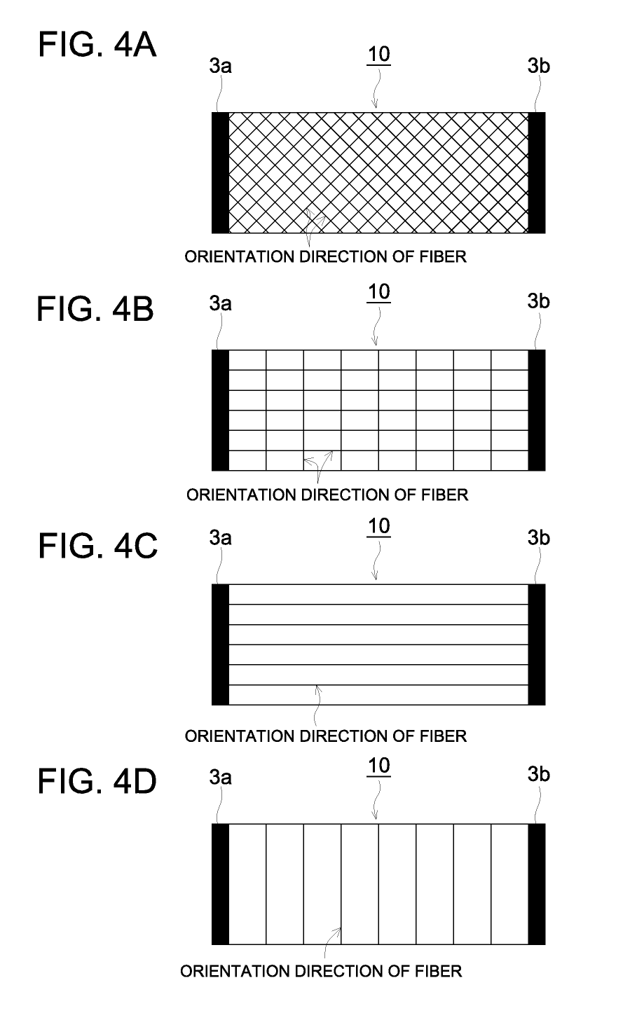

The orientation direction of fibers contained in the insulating layer may be in the oblique direction (as shown in FIG. 4A) or perpendicular and parallel directions (as shown in FIG. 4B) to the direction of an electric current applied between feed electrodes, and parallel direction (as shown in FIG. 4C) is also acceptable but the perpendicular direction (as shown in FIG. 4D) is not preferable. Namely, in one preferred embodiment of the present invention, the fibers contained in the insulating layer are arranged obliquely to the opposing direction of the paired feed electrodes. Further, in one preferred embodiment of the present invention, the fibers are arranged both in the direction parallel to and in the perpendicular to the opposing direction of paired feed electrodes. The reason for the perpendicular direction being not preferable is that, when the heating layer is broken in the perpendicular direction, fixing troubles are markedly caused, so that an insulating resin layer reinforcing the heating layer avoids breakage in the perpendicular direction. The proportion of fibers to the mass of all of an insulating resin layer is not specifically limited, but preferably is from 30 to 70% by mass. Namely, an insulating resin layer preferably contains fibers in an amount of 30 to 70% by mass of the layer.

The form of a fiber is not specifically limited, including a string form, a belt form, a strand form, and a textile form is preferred.

### Insulating Resin:

A resin to form an insulating layer employs a so-called heat-resistant resin. In general, a heat-resistant resin refers to a resin exhibiting a short-term heat resistance of 200° C. or more and a long-term heat resistance of 150° C. or more.

Examples of typical heat-resistant resins include polyphenylene sulfide (PPS), polyacrylate (PAR), polysulfone (PSF), polyether sulfone PES), polyether imide (PEI), polyamidoimide (PAI), and polyether ether ketone (PEEK) resins. In the present invention, a specifically preferable heat-resistant resin is a polyimide resin. Namely, in a preferred embodiment of the present invention, an insulating resin layer and a heating layer, each mainly contains a polyimide resin and, preferably, each contains a polyimide resin in amount of at least 70% by mass.

A polyimide resin is usually formed in such a manner that at least an aromatic diamine and an aromatic tetracarboxylic acid anhydride are polymerized in an organic polar solvent to form a polyimide precursor, followed by imide transformation to form a polyimide resin.

Typical examples of an aromatic diamine include p-phenylenediamine (PPA), m-phenylenediamine (MPDA), 2,5-diaminotoluene, 2,6-diaminotoluene, 4,4′-diaminobiphenyl, 3,3′-dimethyl-4,4′-biphenyl, 3,3′-dimethoxy-4,4′-biphenyl, 2,2′-bis(trifluoromethyl)-4,4′-diaminobiphenyl, 3,3′-diaminodiphenylmethane, 4,4′-diaminodiphenylmethane (MDA), 2,2-bis-(4-aminophenyl)propane, 3,3′-diaminodiphenylsulfone (33DDS), 4,4′-diaminoidiphenylsulfone (44DDS), 3,3′-diaminodiphenylsulfide, 4,4′-diaminodiphenylsulfide, 3,3′-diaminodiphenyl ether, 3,4′-diaminodiphenyl ether (34ODA), 4,4′-diaminodiphenyl ether (ODA), 1,5-diaminodiphenyl silane, 4,4′ diaminodiphenylethylphosphine oxide, 1,3-bis(3-aminophenoxy)benzene (133APB), 1,3-bis(4-aminophenoxy)benzene (134APB), 1,4-bis(4-aminophenoxy)benzene, bis[4-(3-aminophenoxy)phenyl]sulfone (BAPSM), bis[4-(4-aminophenoxy)phenyl]sulfone (BAPS), 2,2-bis[4-(4-aminophenoxy)phenyl]propane (BAPP), 2,2-bis83-aminophenyl)-1,1,1,3,3,3-hexafluoropropane, 2,2-bis(4-aminophenyl)-1,1,1,3,3,3-hexafluoropropane and 9,9-bis(4-aminophenyl)fluorene. Of these, preferred diamines include p-phenylenediamine (PPA), m-phenylenediamine (MPDA), 4,4′-diaminodiphenylmethane (MDA), 3,3′-diaminodiphenylsulfone (33DDS), 4,4′-diaminoidiphenylsulfone (44DDS), 3,4′-diaminodiphenyl ether (34ODA), 4,4′-diaminodiphenyl ether (ODA), 1,3-bis(4-aminophenoxy)benzene (134APB), bis[4-(3-aminophenoxy)phenyl]sulfone (BAPSM), bis[4-(4-aminophenoxy)phenyl]sulfone (BAPS), and 2,2-bis[4-(4-aminophenoxy)phenyl]propane (BAPP).

Typical examples of an aromatic tetracarboxylic acid anhydride include pyromellitic acid anhydride (PMDA), 1,2,5,6-naphthalenetetracarboxylic acid anhydride, 1,4,5,8-naphthalenetetracarboxylic acid anhydride, 2,3,6,7-naphthalenetetracarboxylic acid anhydride, 2,2′,3,3′-biphenyltetracarboxylic acid anhydride, 2,3,3′,4′-biphenyltetracarboxylic acid anhydride, 3,3′4,4′-biphenyltetracarboxylic acid di-anhydride (BPDA), 2,2′,3,3′-benzophenonetetracarboxylic acid dianhydride, 2,3,3′,4′-benzophenoenetetracarboxylic acid anhydride, 3,3′,4,4′-benzophenonetetracarboxylic acid dianhydride (BTDA), bis(3,4-dicarboxyphenyl)sulfone dianhydride, bis(2,3-dicarboxyphenyl)methane dianhydride, bis(3,4-dicarboxyphenyl)methane anhydride, 1,1-bis(2,3-dicarboxyphenyl)ethane anhydride, 1,1-bis(3,4-dicarboxyphenyl)ethane dianhydride, 2,2-bis[3,4-(dicarboxyphenoxy)phenyl]propane anhydride (BPADA), 4,4′-(hexafluoroisopropylidene)-di-phthalic acid anhydride, oxydiphthalic acid anhydride (ODPA), bis(3,4-dicarboxyphenyl)sulfone dianhydride, bis(3,4-dicarboxyphenyl)sulfoxide anhydride, thiodiphthalic acid dianhydride, 3,4,9,10-perrlenetetracarboxylic acid anhydride, 2,3,6,7-anthracene tetracarboxylic acid dianhydride, 1,2,7,8-phenathrenetetracarboxylic acid dianhydride, 9,9-bis(3,4-dicarboxyphenyl)fluorene dianhydride, and 9,9-bis[4-(3,4′-dicarboxyphenoxy)phenyl]fluorene. Of these tetracarboxylic acid anhydrides, pyromellitic acid anhydride (PMDA), acid di-anhydride (BPDA), 3,3′,4,4′-benzophenonetetracarboxylic acid dianhydride (BTDA), 2,2-bis[3,4-(dicarboxyphenoxy)phenyl]propane anhydride (BPADA), and oxydiphthalic acid anhydride (ODPA). These compounds may be reacted with an alcohol such as methanol or ethanol to form ester compounds.

These aromatic diamines and aromatic tetracarboxylic acid anhydrides may be used singly or in their combination. Solutions of plural polyimide precursors are prepared, which may be used in a mixture form.

The foregoing heat-resistant resin may be mixed with various fibers to be used for an insulating resin layer, in which other components (additives, mixtures and the like) may be contained. In the present invention, the heat-resistant resin preferably accounts for at least 40% by volume of all of the resins.

### Method of Forming Insulating Resin Layer:

An insulating resin layer containing fibers is prepared in such a manner that an insulating resin is dissolved in a solvent to form a solution or thermally melted to form a melt, and then, fibers are coated with or immersed in such a solution or melt.

In cases when using a polyimide as an insulating resin, a solution of polyamide acid as a polyimide precursor is coated onto fibers, which is dried and baked to obtain an insulating resin layer.

### Heating Layer:

In the present invention, essential components constituting a heating layer are an electrically conductive material and a resin, and such a resin preferably is a so-called heat-resistant resin.

### Conductive Material:

Typical examples of an electrically conductive material usable in the present invention include a pure metal such as gold, silver iron, or aluminum; an alloy such as stainless steel or nichrome and a non-metal such as carbon or graphite, and it may be in a form of spherical powder, irregular powder, flattened powder or fibers. Graphite or stainless steel is specifically preferred in terms of heating property. The content of a conductive material is preferably within the range of 10 to 50% by mass of the mass of the heating layer.

The expression, the form being fibrous means a long and thin form and refers to the major axis (L) of a fiber being at least 10 times the minor axis (l) which are compared based on the respective average values).

Fibers, as described above, can be produced by commonly known methods. Namely, a material of a fiber form which has been pulled out from a nozzle is further stretched when it is required to be thinner (while being heated as needed), whereby the intended diameter (l) of an electrically conductive fiber is achieved. The thus produced conductive fibers are cut to a prescribed length (L) to obtain a conductive fiber.

Such fibers are a material exhibiting a volume resistivity of 10⁻¹ Ω·m or less and are contained in a heat-resistant resin to prepare a heating element. Further, a heating fixation belt is prepared by using such a heating element.

The volume resistivity can be determined by measurement of a potential difference V (expressed in volt) between electrodes separated at a distance of L when a constant electric current I (ampere) is applied to the sectional area Wxt:

Volume resistivity ρv=VWt/IL

To achieve advantageous effects of the present invention, the diameter (1) of a conductive fiber is desirably not less than 0.5 μm and not more than 30 μm, and the length (L) of a fiber is desirably not less than 5.0 μm and not more than 1000 μm.

The foregoing “L” and “l”, each represents an average value of at least 500 samples. Using a scanning electron microscope, conductive fibers are photographed at a 500-fold magnification and from images read by a scanner, at least 500 fibers are measured with respect to diameter and length and an average value thereof is calculated.

In the present invention, with respect to the reason for a conductive material desirably having a form described above, it is supposed that a fiber diameter of less than 0.5 μm results in excessively increased contact resistance when fibers dispersed in the conductive layer are in contact with each other, rendering it difficult to lower the resistivity of the entire heating layer. It is also supposed that a fiber diameter of more than 30 μm results in a lowering of dispersibility in the heating layer, leading to local fluctuation in resistivity. Further, with respect to fiber length, it is supposed that a length of less than 5.0 μm makes it difficult to form a conduction route of a charge and when the lengths of fibers exceeds 1000 μm, the fibers cannot exist in an elongated form, resulting in local scattering in electric resistance of the heating layer.

### Heat-Resistant Resin:

In the present invention, it is preferred to use a so-called heat-resistant resin as a resin to form a heating layer. In general, a heat-resistant resin refers to one which exhibits a short-term heat resistance of 200° C. or more and a long-term heat resistance of 150° C. or more. Typical examples of a heat-resistant resin are shown below, in which the polyimide resin is specifically preferred in the present invention:

polyphenylene sulfide (PPS), polyacrylate (PAR), polysulfone (PSF), polyether sulfone (PES), polyether imide (PEI), polyimide (PI), polyamide-imide (PAD, and polyether ether ketone (PEEK).

These resins are mixed with an electrically conductive material and used as a heating layer in a heating fixation belt, but is also used as a constituent resin in other layers.

In the present invention, the foregoing heat-resistant resin preferably accounts for at least 40% by volume of all the resins.

### Release Layer:

In the embodiments of the present invention, a release layer of a heating fixation belt preferably is at least a resin selected from the group of polytetrafluoroethylene (PTFE), poly(tetrafluoroethylene-co-perfluoroalkylvinyl ether) (PFE), and poly(tetrafluoroethylene-co-hexafluoropropylene) (FEP).

The thickness of release layer (4) comprised of a fluororesin is preferably 5 to 30 μm, and more preferably 10 to 20 μm. It is also preferred to coat a primer between a heating layer and a release layer to stabilize adhesion property. The thickness of a primer layer preferably is 2 to 5 μm.

### Image Forming Apparatus:

The image forming apparatus of the present invention may employ the commonly known structure, except a fixing device.

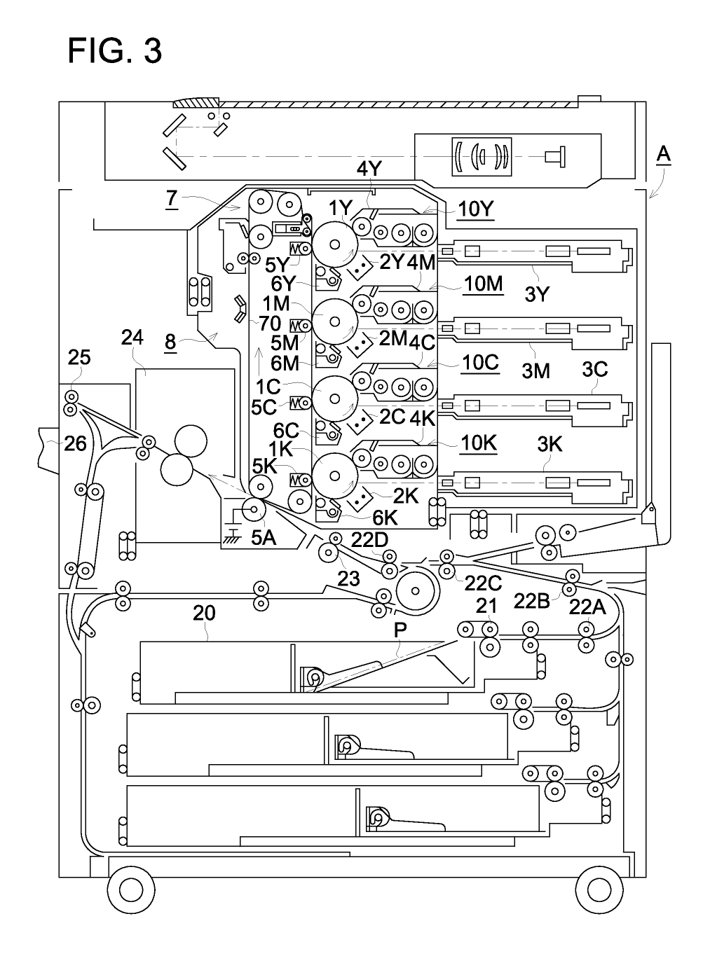

A typical example of the image forming apparatus related to the present is described below with reference to FIG. 3.

In FIG. 3, designations 1Y, 1M, 1C and 1K are each a photoreceptor; 4Y, 4M, 4C and 4K are each a developing device; 5Y, 5M, 5C and 5K are each a primary transfer roll as a primary transfer means; 5A is a secondary transfer roll as a secondary transfer means; 6Y, 6M, 6C and 6K are each a cleaning device; 7 is an intermediate transfer unit, 24 is a heat roll type fixing device, and 70 is an intermediate transfer body unit.

This image forming apparatus is called a tandem color image forming apparatus, which is, as a main constitution, comprised of plural image forming sections 10Y, 10M, 10C and 10K; an intermediate transfer material unit 7 of an endless belt form, a paper feeding and conveying means 21 to convey a recording member P and a heat-roll type fixing device 24 as a fixing means. Original image reading device SC is disposed in the upper section of an image forming apparatus body A.

As one of different color toner images of the respective photoreceptors, image forming section 10Y to form a yellow image comprises a drum-form photoreceptor 1Y as the first photoreceptor; an electrostatic-charging means 2Y, an exposure means 3Y, a developing means 4Y, a primary transfer roller 5Y as a primary transfer means; and a cleaning means 6Y, which are disposed around the photoreceptor 1Y. As another one of different color toner images of the respective photoreceptors, image forming section 10M to form a magenta image comprises a drum-form photoreceptor 1M as the first photoreceptor; an electrostatic-charging means 2M, an exposure means 3M, a developing means 4M, a primary transfer roller 5M as a primary transfer means; and a cleaning means 6M, which are disposed around the photoreceptor 1M.

Further, as one of different color toner images of the respective photoreceptors, image forming section 10C to form a cyan image comprises a drum-foiin photoreceptor 1C as the first photoreceptor; an electrostatic-charging means 2C, an exposure means 3C, a developing means 4C, a primary transfer roller 5C as a primary transfer means; and a cleaning means 6C, which are disposed around the photoreceptor 1C. Furthermore, as one of different color toner images of the respective photoreceptors, image forming section 10K to form a cyan image comprises a drum-form photoreceptor 1K as the first photoreceptor; an electrostatic-charging means 2K, an exposure means 3K, a developing means 4K, a primary transfer roller 5K as a primary transfer means; and a cleaning means 6K, which are disposed around the photoreceptor 1K.

Intermediate transfer unit 7 of an endless belt form is turned by plural rollers and has intermediate transfer material 70 as the second image carrier of an endless belt form, while being pivotably supported.

The individual color images formed in image forming sections 10Y, 10M, 10C and 10K are successively transferred onto the moving intermediate transfer material of an endless belt form by primary transfer rollers 5Y, 5M, 5C and 5K, respectively, to form a composite color image. Recording member P of paper or the like, as a final transfer material housed in a paper feed cassette 20, is fed by paper feed and a conveyance means 21 and conveyed to a secondary transfer roller 5b through plural intermediate rollers 22A, 22B, 22C and 22D and a resist roller 23, and color images are secondarily transferred together on the recording member P. The color image-transferred recording member (P) is fixed by a heat-roll type fixing device 8, nipped by a paper discharge roller 25 and put onto a paper discharge tray 26 outside a machine.

After a color image is transferred onto the recording member P by a secondary transfer roller 5A as a secondary transfer means, an intermediate transfer material of an endless belt form which separated the recording material P removes any residual toner by cleaning means 6A.

During the image forming process, the primary transfer roller 5K is always in contact with the photoreceptor 1K. Other primary transfer rollers 5Y, 5M and 5C are each in contact with the respectively corresponding photoreceptors 1Y, 1M and 1C only when forming a color image.

The secondary transfer roller 5A is in contact with the intermediate transfer material of an endless belt form only when the recording member P passes through to perform secondary transfer.

Thus, toner images are formed on the photoreceptors 1Y, 1M, 1C and 1K via charging, exposure and development, toner images of the respective colors are superimposed on the endless belt intermediate transfer material, transferred together to the recording member P and fixed by applying pressure with heating in the fixing device 24. After having transferred the toner image onto the recording member P, the photoreceptor 1Y, 1M, 1C and 1K are each cleaned in cleaning devices 6Y, 6M, 6C and 6K to remove a remained toner and enter the next cycle of charging, exposure, and development to perform image formation.

A photoreceptor usable in the present invention is not specifically restricted and any one is usable, including an inorganic photoreceptor and an organic photoreceptor.

In FIG. 3, there is used a fixing device 24 of a heating fixation belt system integrating a heating fixation belt 10 and a pressing roller.

### Image Support

An image support (recording material, recording paper or the like) on which images can be formed by use of the toner related to the invention may be any one which is generally used. For instance, it may be any one capable of supporting images formed through commonly known image forming methods by, for example, an image forming apparatus, as described above.

Specific examples of an image support usable in the present invention include plain paper inclusive of thin and thick paper, fine-quality paper, coated paper used for printing, such as art paper or coated paper, commercially available Japanese paper and postcard paper, plastic film used for OHP (overhead projector) and cloth, but are not limited to the foregoing.

### EXAMPLES

In the following, the present invention will be further described with explaining the representative constitution of the present invention and its effects, but the embodiments of the present invention are by no means limited to these.

### Preparation of Dope Solution for Heating Layer

In a planetary mixer were sufficiently mixed 100 g of a polyamide acid (U-varnish 301, produced by Ube Kosan Co., Ltd.), 66 g of polyamidoimide (HPC-9100, produced by Hitachi Kasei Kogyo Co., Ltd.) or 100 g of a 20% methylpyrrolidone solution of a polyamide (AQ nylon P-70, produced by TORAY Co., Ltd.), and 18 g of a conductive material, as shown in Table 1.

There was used, as a conductive material, graphite fibers (XN-100, produced by Nippon Graphite Fiber Co.), stainless steel fiber (NASLON, produced by Nippon Seisen Co., Ltd) or a graphite powder (ACP, produced by Nippon Kokuen Co., Ltd.).

### Preparation of Heating Fixation Belt

### Preparation of Insulating Resin Layer Containing Fibers:

Fibers, as shown in Table 1, were used in a stainless steel tube of a 30 mm outer diameter and a total length of 345 mm.

Aramid fibers (TOWALON, produced by Teijin Co., Ltd.), nylon fibers (Polyamide 6.6, produced by du Pont de Nemours & Co.), a commercially available hemp fibers, glass fibers (produced by Nitobo Co., Ltd.) and Teflon fibers (Toyoflon, produced by TORAY Co., Ltd.), which were each woven in a prescribed orientation, were further woven into a cylindrical form. The thus cylindrically woven materials, which were each loaded onto a stainless steel tube. Onto the thus fiber-loaded stainless steel tube was coated polyamic acid, a polyamide or a polyamidoimide at a thickness of 500 μm to form a resin layer, in which the fibers accounted for 37% by mass of the insulating resin layer. The thus coated tubes were dried at 120° C. for 20 minutes.

TABLE 1

| | Insulating Resin Layer | | | Heating Layer | |
|---|---|---|---|---|---|
| Example | Orientation of | | | Conductive | |
| No. | Fiber | Fiber | Resin | Material | Resin |
| 1 | oblique direction | aramid | polyimide | graphite fiber | polyimide |
| 2 | parallel direction | aramid | polyimide | graphite fiber | polyimide |
| 3 | perpendicular and | aramid | polyimide | graphite fiber | polyimide |
| | parallel direction | | | | |
| 4 | oblique direction | nylon | polyimide | stainless steel | polyimide |
| | | | | fiber | |
| 5 | oblique direction | hemp | polyimide | graphite fiber | polyimide |
| 6 | oblique direction | glass | polyimide | graphite fiber | polyimide |
| 7 | oblique direction | Teflon | polyimide | stainless steel | polyimide |
| | | | | fiber | |
| 8 | oblique direction | aramid | polyamide | graphite fiber | polyamidoimide |
| 9 | parallel direction | aramid | polyamidoimide | stainless steel | polyimide |
| | | | | fiber | |
| 10 | perpendicular and | aramid | polyamide | graphite fiber | polyimide |
| | parallel direction | | | | |
| 11 | oblique direction | nylon | polyamide | stainless steel | polyamidoimide |
| | | | | fiber | |
| 12 | oblique direction | aramid | polyamidoimide | graphite powder | polyamide |
| Comp. 1 | — | — | polyimide | graphite fiber | polyimide |
| Comp. 2 | — | — | polyamidoimide | graphite powder | polyamide |

### Preparation of Heating Layer:

On the thus dried material was coated a dope for a heating layer at a thickness of 500 μm. The thus coated layer was dried at 150° C. for 3 hours and further dried at 320° C. for 120 minutes under an atmosphere of nitrogen, and then removed from the stainless steel tube, whereby a heating fixation belt as a resin tubing was prepared.

### Preparation of Elastomer Layer:

A primer (X331565, produced by Shinetsu Kagaku Co., Ltd.) was coated by a brush on the foregoing polyimide resin tubing loaded on the stainless steel tube and dried at ordinary temperature for 30 minutes.

Then, a composition of a liquid rubber of silicone rubber (KE1379, produced by Shinetsu Kagaku Co., Ltd.) and silicone rubber (DY356013, produced by Dow Corning Toray Co., Ltd.) which were previously mixed at a ratio of 2:1 was coated on the outer surface of the polyimide resin tubing at a thickness of 200 μm to form a silicone rubber layer.

Thereafter, primary curing was carried out at 150° C. over 30 minutes and post-curing was further carried out at 200° C. over 4 hours to obtain a tubing provided with a 200 μm thick silicone rubber layer formed on the outer surface of the polyimide resin tubing. The hardness of the thus formed rubber layer was 26 degrees.

### Preparation of Release Layer:

After cleaning the silicone rubber surface, the tubing was immersed in a PTFE resin dispersion (trade name 30J, produced by produced by du Pont de Nemours & Co.), as a fluororesin (B), over 3 minutes, while being rotated, and taken out therefrom and dried at ordinary temperature over 20 minutes; subsequently, the silicone resin on the silicone rubber surface was wiped off with a cloth.

Then, the tubing of polyimide resin and silicone rubber was immersed in a fluororesin dispersion (trade name 855-510, produced by du Pont de Nemours & Co.) in which PTFE resin and PFA resin, as a fluororesin (A), were mixed at a ratio of 7:3 and adjusted to a solid content of 45% and a viscosity of 110 mPa·s, and coated so that the final thickness was 15 μm, dried at room temperature over 30 minutes and then heated at 230° C. over 30 minutes. Thereafter, the tubing was allowed to pass through a tubular furnace of an inner diameter of 100 mm and furnace temperature of 270° C. over a period of 10 minutes, whereby a silicone resin coated on the silicone rubber surface was burned. Subsequently, after being cooled, the tubing was separated from the metal mold, whereby the objective heating fixation belt was obtained.

### Performance Evaluation

### Initial Heating and Heating After Being Folded:

A heating fixation belt provided with a heating layer, as shown in each of Examples 1-12 and Comparisons 1-2 of Table 1, was loaded to a fixation device having a constitution, as shown in FIG. 2. The belt was driven at a linear speed of 210 mm/sec, while applying voltage of 100 V to the heating layer and the time to reach 180° C. from the start of energization (which was denoted as initial heating) was measured. In cases when not reaching 180° C. within 10 seconds, the temperature after 10 seconds from the start of energization was measured as initial heating.

Using A4-size fine-quality paper (64 g/m²), there were printed 10 sheets of mixed images composed of a text image having a picture element ratio of 7%, a portrait photographic image, a solid white image and a solid black image, formed on fine-quality Paper of 64 g/m². Thereafter, the heating fixation belt was removed and a needle of 1 mm diameter was penetrated at the central portion in the longitudinal direction of the belt to damage the heating layer of the belt. Then, the belt was completely folded around the damaged portion in the longitudinal direction until both ends were completely attached to each other. Further, folding was repeated in the opposite direction, which represented one operation. After repeating this operation five times, the foregoing heating test (heating after being folded) and printing were conducted. Penetration by a needle corresponds to damage of a belt, caused by incorporation of foreign mater, and folding test corresponds to enormous-pulling of paper at the time of paper jam. The surfaces of the prints of the 10th and the 1000th sheets were lightly rubbed with gauze and visually observed with respect to attachment of toner particles onto the gauze. In Table 2, the presence or absence of such attachment of toner particles onto the gauze was denoted as “yes” or “no”.

TABLE 2

| | | Heating | Attachment of Toner | | Attachment of Toner | |
|---|---|---|---|---|---|---|
| | Initial | after | to Gause in Image | | to Gause in Image | |
| Exam- | Heat- | Being | at Initial Stage | | after Being Folded | |
| ple | ing | Folded | 10th | 1000th | 10th | 1000th |
| No. | (sec.) | (sec.) | Sheet | Sheet | Sheet | Sheet |
| 1 | 5 | 5 | no | no | no | no |
| 2 | 5 | 5 | no | no | no | no |
| 3 | 3 | 5 | no | no | no | no |
| 4 | 3 | 5 | no | no | no | no |
| 5 | 5 | 5 | no | no | no | yes |
| 6 | 5 | 5 | no | no | no | yes |
| 7 | 5 | 5 | no | no | no | yes |
| 8 | 5 | 5 | no | no | no | yes |
| 9 | 15 | 25 | no | yes | no | yes |
| 10 | 5 | 5 | no | yes | no | yes |
| 11 | 5 | 5 | no | yes | no | yes |
| 12 | 25 | 27 | no | yes | no | yes |
| 13 | 360 | 455 | no | yes | no | yes |
| Comp. | 5 | 100° | no | yes | yes | yes |
| 1 | | C. | | | | |
| Comp. | 170° | 170° | no | yes | yes | yes |
| 2 | C. | C. | | | | |

As is apparent from Table 2, it was proved that, among Examples related to the present invention, Examples 1-4 each achieved excellent performance in any of characteristics.

What is claimed is:

1. A heating fixation belt comprising an insulating resin layer containing fibers, a heating layer containing an electrically conductive material dispersed in a resin and having a pair of feed electrodes provided on both ends and a releasing layer, which are sequentially provided in that order.

2. The heating fixation belt of claim 1, wherein the insulating resin layer contains the fibers which are arranged obliquely to an opposing direction of the pair of feed electrodes.

3. The heating fixation belt of claim 1, wherein the insulating resin layer contains the fibers which are arranged both in a direction parallel to and in a direction perpendicular to an opposing direction of the pair of feed electrodes.

4. The heating fixation belt of claim 1, wherein the insulating resin layer and the heating layer contain a polyimide resin.

5. The heating fixation belt of claim 1, wherein the electrically conductive material is graphite fibers or stainless steel fibers.

6. An image forming apparatus comprising a heating fixation belt that comprises an insulating resin layer containing fibers, a heating layer containing an electrically conductive material dispersed in a resin and having a pair of feed electrodes provided on both ends and a releasing layer, which are sequentially provided in that order.

7. The image forming apparatus of claim 6, wherein the insulating resin layer contains the fibers which are arranged obliquely to an opposing direction of the pair of feed electrodes.

8. The image forming apparatus of claim 6, wherein the insulating resin layer contains the fibers which are arranged both in a direction parallel to and in a direction perpendicular to an opposing direction of the pair of feed electrodes.

9. The image forming apparatus of claim 6, wherein the insulating resin layer and the heating layer contain a polyimide resin.

10. The image forming apparatus of claim 6, wherein the electrically conductive material is graphite fibers or stainless steel fibers.
